(19) United States
(12) Patent Application Publication
(10) Pub. No.: US 2026/0131731 A1
(43) Pub. Date: May 14, 2026

(54) LANE DISTANCE LINE OVERLAY SYSTEMS AND METHODS

(71) Applicant: Stoneridge Electronics AB, Solna (SE)

(72) Inventors: Banuprakash Murthy, Novi, MI (US); Troy Cooprider, White Lake, MI (US); Liang Ma, Rochester, MI (US)

(21) Appl. No.: 18/945,809

(22) Filed: Nov. 13, 2024

(51) Int. Cl. B60R 1/25; G06T 7/50; G06V 10/56; G06V 10/70; G06V 20/56

(52) U.S. Cl. CPC B60R 1/25; G06T 7/50; G06V 20/588; B60R 2300/308; B60R 2300/804; B60R 2300/8046; G06T 2207/30256; G06V 10/56; G06V 10/70

(57) ABSTRACT

A method of monitoring a vehicle includes capturing an image of a field of view adjacent the vehicle, displaying at least a portion of the image, detecting a lane boundary for the vehicle, determining a distance between the lane boundary and the vehicle, and overlaying the distance onto the displayed image

### BACKGROUND

Mirror replacement systems, and camera systems for supplementing mirror views, are utilized in commercial vehicles to enhance the ability of a vehicle operator to see a surrounding environment. Camera monitor systems (CMS) utilize one or more cameras disposed about the vehicle to provide an enhanced field of view to a vehicle operator on one or more displays located in the vehicle cabin. In some examples, mirror replacement systems within the CMS can cover a larger field of view than a conventional mirror, or can include views that are not fully obtainable via a conventional mirror.

### SUMMARY

A method of monitoring a vehicle according to one or more examples of this disclosure may include: (a) capturing an image of a field of view adjacent the vehicle; (b) displaying at least a portion of the image; (c) detecting a lane boundary for the vehicle; (d) determining a distance between the lane boundary and the vehicle; and (e) overlaying the distance onto the displayed image.

In a further example of any of the disclosed examples, step (e) is performed if the distance is less than a predetermined threshold value.

In a further example of any of the disclosed examples, the method includes outputting an alert image if the distance is less than a predetermined threshold value.

In a further example of any of the disclosed examples, step (c) includes identifying a lane marking in a roadway, the captured image including the lane marking, and the identifying is performed by at least one of filtering a color of the lane marking and deep learning from a surrounding portion of the captured image.

In a further example of any of the disclosed examples, the distance is a lateral distance between a feature on the vehicle and the lane boundary.

In a further example of any of the disclosed examples, the overlayed distance includes a dimension line extending from the vehicle to the lane boundary.

In a further example of any of the disclosed examples, the dimension line is labeled with a numerical value of the distance.

In a further example of any of the disclosed examples, the distance is a lateral distance between a feature on the vehicle and the lane boundary.

In a further example of any of the disclosed examples, the method includes f) detecting one or more of a vehicle maneuver, condition, parameter, or location; and g) selecting a reference point on the vehicle for determining the distance based on the detection in step (f).

In a further example of any of the disclosed examples, step (g) includes selecting one or more of a tractor tire or a trailer tire as the reference point.

A camera monitor system (CMS) for a vehicle according to one or more examples of this disclosure includes a camera configured to provide a captured image of a field of view. A display is in communication with the camera and configured to depict a displayed image including at least a portion of the captured image. A controller includes processing circuitry configured to detect a lane boundary for the vehicle, determine a distance between the vehicle and the lane boundary, and overlay the distance onto the displayed image.

In a further example of any of the disclosed examples, the camera is a rear facing camera mounted to a tractor, and the field of view captures at least a portion of a trailer.

In a further example of any of the disclosed examples, the distance is a lateral distance between a feature on the vehicle and the lane boundary.

In a further example of any of the disclosed examples, the overlayed distance includes a dimension line extending from the vehicle to the lane boundary.

In a further example of any of the disclosed examples, the dimension line is labeled with a numerical value of the distance.

In a further example of any of the disclosed examples, the distance is a lateral distance between a feature on the vehicle and the lane boundary.

In a further example of any of the disclosed examples, the feature is a tire.

In a further example of any of the disclosed examples, the processing circuitry configured to perform the overlay if the distance is less than a predetermined threshold value.

In a further example of any of the disclosed examples, the processing circuitry is configured to detect one or more of a vehicle maneuver, condition, parameter, or location, and select a reference point on the vehicle for determining the distance based on the detection of the one or more of the vehicle maneuver, condition, parameter, or location.

In a further example of any of the disclosed examples, the reference point is a tire.

These and other features may be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1A is a schematic front view of a commercial truck with a camera monitor system (CMS) used to provide at least Class II and Class IV views.

FIG. 1B is a schematic top elevational view of a commercial truck with a camera mirror system providing Class II, Class IV, Class V, Class VI and Class VIII views.

FIG. 2 is a schematic illustration of an interior of a vehicle cab and the CMS system.

FIG. 3 illustrates an image captured by the example CMS system.

FIG. 4 illustrates another image captured by the example CMS system.

FIG. 5 illustrates an example display with an overlay.

FIG. 6 is a flowchart of an example method of monitoring a vehicle.

### DETAILED DESCRIPTION

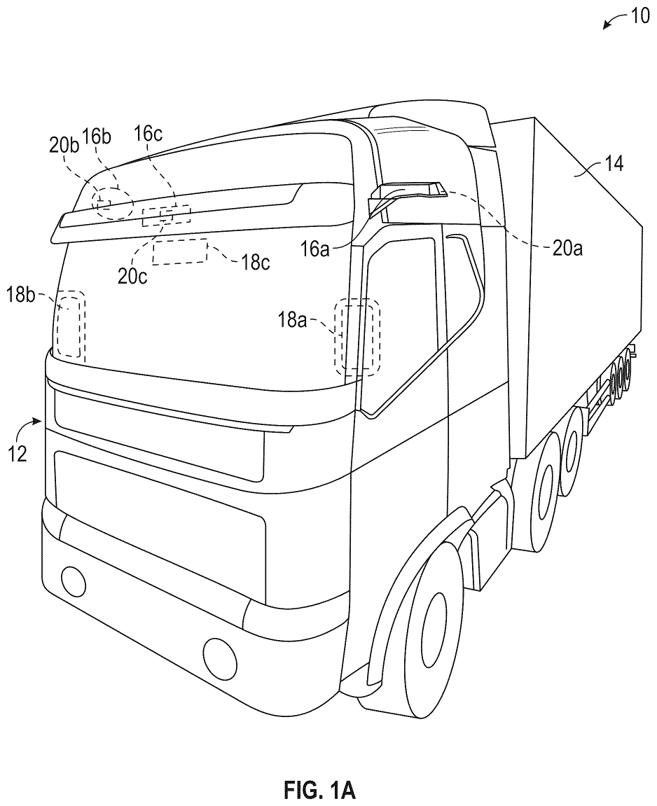

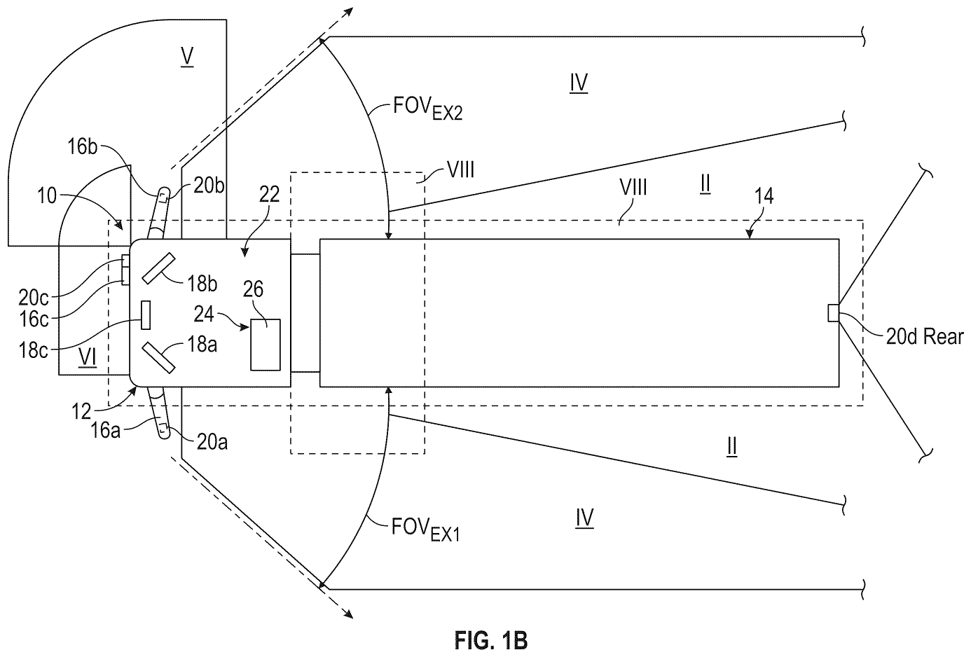

A schematic view of a commercial vehicle 10 is illustrated in FIGS. 1A and 1B. FIG. 2 is a schematic top perspective view of the vehicle 10 cabin including displays and interior cameras. The vehicle 10 includes a vehicle cab or tractor 12 for pulling a trailer 14. It should be understood that the vehicle cab 12 and/or trailer 14 may be any configuration. Although a commercial truck is contemplated in this disclosure, the invention may also be applied to other types of vehicles. The vehicle 10 incorporates a camera monitor system (CMS) 15 (FIG. 2) that has driver and passenger side camera arms 16 a, 16 b (generally, “camera arm 16” or “wing”) mounted to the outside of the vehicle cab 12. If desired, the camera arms 16a, 16b may include conventional mirrors integrated with them as well, although the CMS 15 can be used to entirely replace mirrors. In additional examples, each side can include multiple camera arms, each arm housing one or more cameras and/or mirrors.

Each of the camera arms 16a, 16b includes a base that is secured to, for example, the cab 12. A pivoting arm is supported by the base and may articulate relative thereto. Fixed wings may also be used. At least one rearward facing camera 20a, 20b is arranged respectively within camera arms. The exterior cameras 20a, 20b each have an image capture unit that capture an exterior field of view FOV_{EX1}, FOV_{EX2} that each include at least one of the Class II and Class IV views (FIG. 1B), which are legal prescribed views in the commercial trucking industry. It is desirable to capture at least a portion of the trailer 14 in the field of view, for example, the side and/or end of the trailer, throughout vehicle operation. Multiple cameras also may be used in each camera arm 16a, 16b to provide these views, if desired. Class II and Class IV views are defined in European R46 legislation, for example, and the United States and other countries have similar drive visibility requirements for commercial trucks. Any reference to a “Class” view is not intended to be limiting, but is intended as exemplary for the type of view provided to a display by a particular camera. Each arm 16a, 16b may also provide a housing that encloses electronics that are configured to provide various features of the CMS 15.

First and second video displays 18a, 18b are arranged on each of the driver and passenger sides within the vehicle cab 12 on or near the A-pillars 19a, 19b to display Class II (narrow angle view) and Class IV (wide angle view) views (e.g., Class II depicted above Class IV in a portrait-style configuration) on its respective side of the vehicle 10, which provide rear facing side views along the vehicle 10 (e.g., portions of the trailer) that are captured by the exterior cameras 20a, 20b.

If video of Class V and/or Class VI views are also desired, a camera housing 16c and camera 20c may be arranged at or near the front of the vehicle 10 to provide those views (FIG. 1B). A third display 18c arranged within the cab 12 near the top center of the windshield can be used to display the Class V and Class VI views, which are toward the front of the vehicle 10, to the driver. The displays 18a, 18b, 18c face a driver region 24 within the cabin 22 where an operator is seated on a driver seat 26. The location, size and field(s) of view streamed to any particular display may vary from the configurations described in this disclosure and still incorporate the disclosed invention.

If video of Class VIII views is desired, camera housings can be disposed at the sides and rear of the vehicle 10 to provide fields of view including some or all of the Class VIII zones of the vehicle 10. As illustrated, the Class VIII view includes views immediately surrounding the trailer, and in the rear proximity of the vehicle including the rear of the trailer. In one example, a view of the rear proximity of the vehicle is generated by a rear facing camera disposed at the rear of the vehicle, and can include both the immediate rear proximity and a traditional rear view (e.g. a view extending rearward to the horizon, as may be generated by a rear view mirror in vehicles without a trailer). In such examples, the third display 18c can include one or more frames displaying the Class VIII views. Alternatively, additional displays can be added near the first, second and third displays 18 a, 18 b, 18 c (generally, “display 18”) and provide a display dedicated to providing a Class VIII view.

In some cases, the Class VIII view is generated using a trailer mounted camera 30. The trailer mounted camera 20d is a rear facing camera which provides a field of view behind the trailer. This rear view can be provided to one of the displays 18a, 18b and/or another display 18c within the vehicle cabin 22 as a rear view mirror replacement or as a rear view mirror supplement. This view is particularly beneficial as the trailer 14 may block some, or all, views provided by a conventional rear view mirror.

The CMS 15 is also configured to utilize the images from the cameras 20 a, 20 b, 20 c, 20 d (generally, “camera 20”) as well as images from other cameras that may be disposed about the vehicle or in communication with the vehicle to determine features of the vehicle, identify objects, and facilitate driver assistance features such as display overlays and semi-automated driver assistance systems.

These features and functions of the CMS 15 are used to implement multiple CMS 15 systems that aid in operation of the vehicle. It should be noted that a controller 30 (FIG. 2) for the CMS 15 can be used to implement the various functionalities disclosed in this application. The controller 30, which is in communication with the displays 18 and cameras 20, may include one or more discrete units. For example, a centralized architecture may have a common controller arranged in the vehicle 10, while a decentralized architecture may use a controller provided in each of the displays 18, for example. Moreover, a portion of the controller 30 may be provided in the vehicle 10, while another portion of the controller 30 may be located elsewhere, for example, the camera arms 16. In another example, a master-slave display configuration may be used where one display includes the controller 30 while the other display receives the commands from the controller 30.

In terms of hardware architecture, such a controller can include a processor, memory (e.g., memory 31, FIG. 2), and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller 30 may be a hardware device for executing software, particularly software stored in memory (e.g., memory 31, FIG. 2). The controller 30 can be a custom made or commercially available processor, a central processing unit (CPU), an auxiliary processor among several processors associated with the controller, a semiconductor-based microprocessor (in the form of a microchip or chip set) or generally any device for executing software instructions.

The memory 31 can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory 31 may incorporate electronic, magnetic, optical, and/or other types of storage media. The memory 31 can also have a distributed architecture, where various components are situated remotely from one another, but can be accessed by the processor.

The software in the memory 31 may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory 31.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller 30 is in operation, the processor can be configured to execute software stored within the memory 31, to communicate data to and from the memory 31, and to generally control operations of the computing device pursuant to the software. Software in memory 31, in whole or in part, is read by the processor, perhaps buffered within the processor, and then executed.

In various examples, the controller 30 includes one or modules having algorithm(s), equation(s) and/or decision manager(s) that receive input(s) from sensors and/or stored values. Example modules include Lane Detection Module 100, Object Detection Module 101, and Distance Determination Module 102. Example inputs include a steering angle sensor 32, a vehicle speed sensor 34, and other sensor data. Vehicle configuration information 36, which relates to vehicle characteristics (e.g., trailer length, axle position, trailer type/wheelbase, tractor configuration/wheelbase, hitch point location etc.), may be provided by the manufacturer, operator, and/or determined by one or more of the modules. During vehicle operation, the controller 30 may communicate information to the driver, fleet operator, or others using an output 39 (e. g, displays 18, speaker, etc.).

The lane detection module 100 also uses image processing of the captured images to identify markings or other features that define a lane boundary on the roadway, such as lane markers that visually divide adjacent lanes. An example algorithm may include using image processing to detect edges and identify lane markings. One example algorithm is described in United States Publication No. US2023/117,719, entitled “CAMERA MIRROR SYSTEM DISPLAY FOR COMMERCIAL VEHICLES INCLUDING SYSTEM FOR IDENTIFYING ROAD MARKINGS”, which is incorporated by reference in its entirely. In that publication, a lane detection module is described in which an object detection algorithm identifies a lane marking in a roadway by filtering a color of the lane marking from a surrounding portion of the captured image. Other techniques based upon deep learning technology or another computer vision method may be used, if desired. A deep learning model could be trained to determine the distance between the lane marking and the vehicle. In some examples, the model could be trained based on a dataset of images labeled with known distances between the vehicle and identified objects.

The object detection module 101 includes one or more image processing algorithms configured to identify objects in the captured images. The algorithms may be used to identify VRU's (e.g., pedestrians or cyclists), attributes of the tractor 12 and/or trailer 14, other vehicles, signs, curbs, medians, trees, buildings and/or other inanimate objects.

A distance determination module 102 may include one or more algorithms to determine a distance between the detected lane boundary or other object and the vehicle 10.

The CMS 15 may utilize one or more of the lane detection module 100, object detection module 101, and distance determination module 102 to detect a lane boundary or other object (e.g., any object detected by the object detection module 101), determine a distance between the lane boundary or other object and the vehicle, and overlay the determined distance onto a display 18.

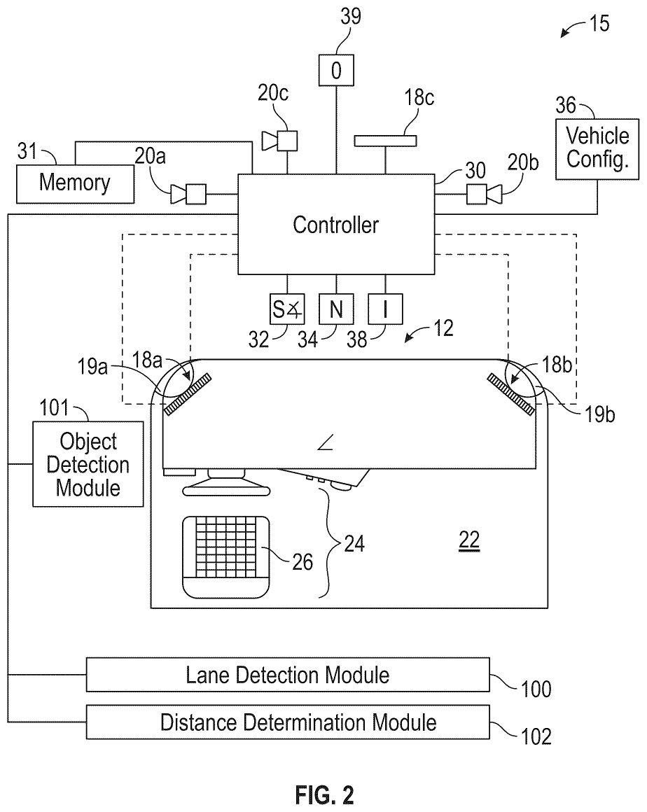

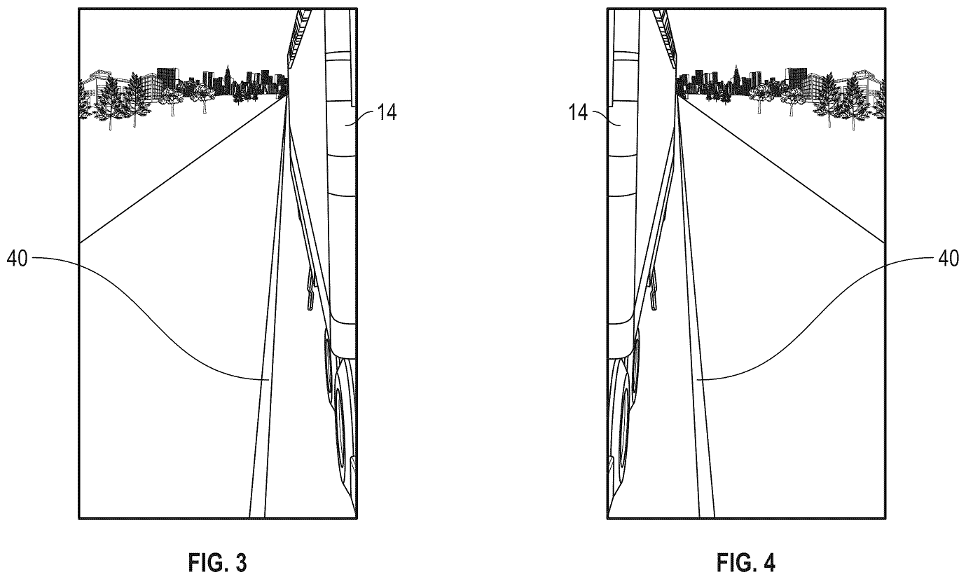

As illustrated in FIGS. 3 and 4, with continued reference to FIGS. 1A-2, the CMS 15 may capture one or more images of a field of view from one or more of the cameras 20. The field of view may include an area adjacent the vehicle 10. The field of view may include an area lateral to the vehicle 10. FIG. 3 illustrates an image captured by the camera 20b. FIG. 4 illustrates an image captured by the camera 20a. The field of view may include a portion of the trailer 14.

In implementations, the field of view may include lane markings 40 or other features that define a lane boundary or other objects near the vehicle 10 while the vehicle 10 is in motion. The captured image may be displayed on a display 18. In implementations, images may be captured by one or both of the cameras 20a, 20b and may include lane markings 40 on lateral sides of the vehicle 10 during vehicle operation. The lane markings 40 may include dashed and/or solid lines in some implementations.

Within the captured image or images, the CMS 15 may detect a lane boundary or other object using camera(s) 20 and image processing, such as with the lane detection module 100 or object detection module 101. In implementations, the CMS 15 may determine the lane boundary by detecting one or more lane markings 40 or other similar features by filtering a color of the lane marking from a surrounding portion of the captured image. In implementations, lane markings 40 may be detected on one or both lateral sides of the vehicle 10, such as the most immediate lane markings within the lane the vehicle 10 is traveling. In implementations, the CMS 15 may detect a lane boundary using a deep neural network model trained to detect one or more lane markings 40. In implementations, the deep neural network model may be trained with a dataset of multiple images classified as having lane markings and/or multiple images classified as being without lane markings. In implementations, a DNN model can be trained for lane detection by gathering a dataset with labeled examples of the lane in the image, and using a neural network model to learn patterns in the data that distinguish the lane from the rest of the image. Although lane markings 40 are shown in the illustrative example, a lane boundary may be determined by detecting other features that define a lane boundary, such as a road edge, curb, or guardrail in some implementations.

The CMS 15 may further determine a distance between the detected lane boundary or other object and the vehicle 10. In implementations, the distance determination may include transforming the 2D image data from the captured image or images into a 3D coordinate system. The cameras 20 may be calibrated to map mapping pixel coordinates from the 2D image to the 3D space surrounding the vehicle. Calibration may include determining the camera 20 intrinsic parameters (e.g., focal length, lens distortion) and extrinsic parameters (e.g., camera position and orientation relative to the vehicle).

The 2D image pixels, including the identified lane markings 40 or other object, may then be transformed into 3D points, such as by projecting the 2D image data onto a known 3D ground plane (e.g., the road surface) using the camera's extrinsic and intrinsic parameters. In implementations, a homography transformation may be utilized to map the 2D plane of the camera image to the 3D world. The CMS 15 may then utilize the 3D information to determine the distance between the vehicle 10 and the lane markings 40 or other object. In implementations, the determined distance is the lateral distance between a feature of the vehicle 10 and the lane markings 40 or other object. Other distance determination methods may be utilized. In some implementations, a DNN model may determine distance with LiDAR ground truthing with one or more LiDAR sensors for validating or verifying data.

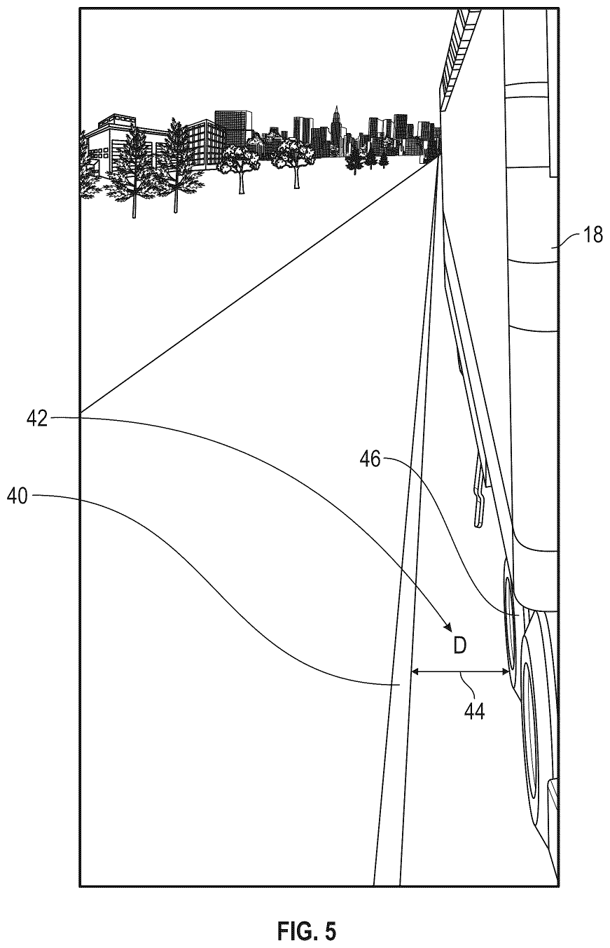

As shown in FIG. 5, the CMS 15 may then provide an overlay 42 of the distance D onto the displayed image on the display 18. In implementations, the display 18 may be one or both of the displays 18a, 18b (see FIGS. 1A-2). In implementations, the overlay 42 may include a dimension line 44 extending from the vehicle 10 to the lane marking 40. The dimension line 44 may be perpendicular to the lane marking 40. The dimension line 44 may be labeled with the distance D, as shown, which may include a numerical value and an indication of the units of measurement. In implementations, the overlay 42 may be displayed if the distance D is below a predetermined threshold value.

In implementations, the overlay 42 may be color coded depending on the determined distance. For example, if a distance D is below a predetermined threshold value, the overlay 42 may be a first color, and if the distance D is above the predetermined threshold value, the overlay 42 may be a second, different color. The overlay 42 may be combined with additional alerts to the vehicle operator if the distance D is below a predetermined threshold value. In implementations, the overlay 42 may be provided on a bird's eye view (BEV) display of the vehicle 10.

The distance D may be a lateral distance between a lane boundary and a feature of the vehicle, such as a tire 46 as shown. The tire 46 may be a tire on the tractor 12 or the trailer 14. In implementations, multiple distances may be determined and/or overlayed relative to various features along the vehicle 10. For example, a distance from a tractor tire to a lane boundary and a distance from a trailer tire to a lane boundary may be determined and overlayed. In some implementations, the distance reference point on the vehicle 10 may be selected based upon a detected maneuver, condition, parameter, and/or location of the vehicle 10.

In implementations, the detection, determination and/or overlay may be triggered by a vehicle maneuver, such as a turn, lane change, use of a highway ramp, or other similar operation in which additional information may be useful to the vehicle operator. For example, the CMS 15 may detect a vehicle maneuver and initiate the lane or object detection, distance determination, and/or overlay in response. In implementations, the lane or object detection, distance determination, and/or overlay may be initiated in response to a detected steering angle above a predetermined threshold value. In implementations, the lane or object detection, distance determination, and/or overlay may be initiated in response to a manual command from the vehicle operator.

In implementations, the CMS 15 may select the distance reference point on the vehicle 10 from a number of possible reference points for distance determination and/or overlaying based on a detected maneuver, condition, parameter, location, or combinations thereof, of the vehicle 10. As one example, for left or right 90 degree turns, the CMS 15 may select as a reference point a trailer tire so as to prevent a curb strike event or the like. As another example, for lane changes, the CMS 15 may select as reference points both tractor and trailer tires for transition smoothness. As another example, on highway entry and exit ramps, the CMS 15 may select as a reference point a trailer tire, such as to avoid crossing the road edge. As another example, for reverse situations, the CMS 15 may select as a reference point the trailer tire, such as to avoid parking over parking lines. As another example, in straight driving situations, the CMS 15 may select as a reference point a tractor tire for lane departure warnings. As another example, in straight driving situations, the CMS 15 may select as a reference point a trailer tire for trailer lane departure warnings.

In implementations, the CMS 15 may switch from one selected distance reference point on the vehicle 10 to a second, different selected distance reference point on the vehicle 10 for distance determination and/or overlaying based on a detected maneuver, condition, parameter, location, or combinations thereof, of the vehicle 10. In implementations, the CMS 15 may add a second, different selected distance reference point on the vehicle 10 for distance determination and/or overlaying based on a detected maneuver, condition, parameter, location, or combinations thereof, of the vehicle 10, such that a first reference point, and the second, different reference point are utilized. For example, the CMS 15 may utilize a tractor tire as a reference point, detect a vehicle maneuver such as a turn or lane change, and the switch to or add the trailer tire as a reference point.

In implementations, an alert to the vehicle operator may be output if the distance is below a predetermined threshold value. In implementations, an alert may be output if intersection between the vehicle and the lane boundary is imminent.

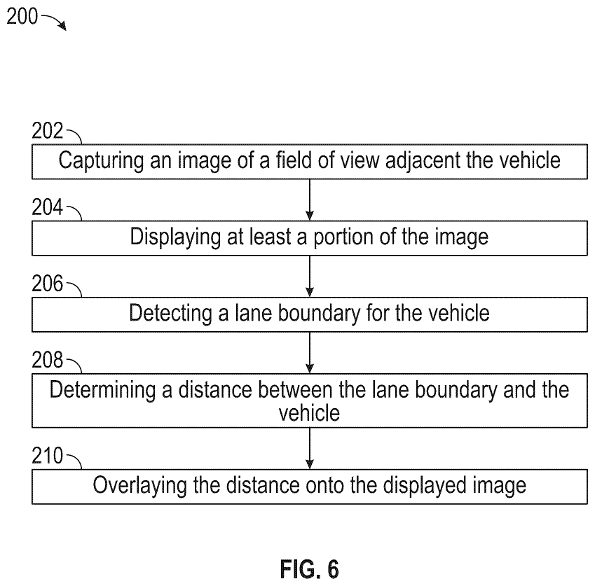

FIG. 6 illustrates a flowchart of an example method 200 of monitoring a vehicle 10 that may be utilized with the systems disclosed herein. Fewer or additional steps than are recited below could be performed within the scope of this disclosure, and the recited order of steps is not intended to limit this disclosure.

At 202, an image of a field of view adjacent the vehicle is captured, such as by any of the cameras 20 disclosed herein.

At 204, at least a portion of the image is displayed, such as on any of the displays 18 disclosed herein.

At 206, a lane boundary or other object for the vehicle 10 is detected. At 208, the distance between the lane boundary or other object and the vehicle is determined. Step 208 may be performed after step 206.

At 210, the determined distance is overlayed onto the displayed image. In implementations, the distance may be overlayed onto the displayed image if the distance is less than a predetermined threshold value. In implementations, an alert may be output if the distance is less than a predetermined threshold value.

One or more steps of the method 200 may be initiated automatically based on a triggering event, such as a vehicle maneuver, parameter, and/or location. One or more steps of the method 200 may be initiated based on a manual input from a vehicle operator. The method 200 may include detecting one or more of a vehicle maneuver, condition, parameter, or location, and selecting a reference point on the vehicle for determining the distance based on that detection. The method 200 may include detecting one or more of a vehicle maneuver, condition, parameter, or location, and switching from a reference point on the vehicle to a second, different reference point on the vehicle for determining the distance based on that detection. The method 200 may include detecting one or more of a vehicle maneuver, condition, parameter, or location, and adding a second, different reference point on the vehicle for determining the distance based on that detection.

The systems and methods described herein may assist the vehicle operator in keeping the vehicle within lanes or away from other objects, such as during vehicle maneuvers in which additional information is valuable. Overlaying the distance to a lane boundary can assist the driver in making decision. In implementations, camera monitor systems may provide different depth information than physical mirrors provide, so it may be helpful to provide the vehicle operator with a quantifiable numerical distance.

The systems and methods disclosed herein may use deep learning or other computer vision methods to enhance accuracy.

A method of monitoring a vehicle may be said to include (a) capturing an image of a field of view adjacent the vehicle; (b) displaying at least a portion of the image; (c) detecting a lane boundary for the vehicle; (d) determining a distance between the lane boundary and the vehicle; and (e) overlaying the distance onto the displayed image.

A camera monitor system (CMS) for a vehicle may be said to include a camera configured to provide a captured image of a field of view. A display may be in communication with the camera and configured to depict a displayed image including at least a portion of the captured image. A controller may include processing circuitry configured to: detect a lane boundary for the vehicle, determine a distance between the vehicle and the lane boundary, and overlay the distance onto the displayed image. While described above in relation to a commercial tractor pulling a trailer, it is appreciated that the systems and methods described herein are applicable to any similar vehicle configurations and are not limited to commercial tractor trailer configurations.

Although the different examples are illustrated as having specific components, the examples of this disclosure are not limited to those particular combinations. It is possible to use some of the components or features from any of the embodiments in combination with features or components from any of the other embodiments.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method of monitoring a vehicle, comprising:
a) capturing an image of a field of view adjacent the vehicle;
b) displaying at least a portion of the image;
c) detecting a lane boundary for the vehicle;
d) determining a distance between the lane boundary and the vehicle; and
e) overlaying the distance onto the displayed image.

2. The method of claim 1, step (e) is performed if the distance is less than a predetermined threshold value.

3. The method of claim 1, comprising:
outputting an alert image if the distance is less than a predetermined threshold value.

4. The method of claim 1, wherein step (c) includes identifying a lane marking in a roadway, wherein the captured image including the lane marking, wherein the identifying is performed by at least one of filtering a color of the lane marking and deep learning from a surrounding portion of the captured image.

5. The method of claim 1, wherein the distance is a lateral distance between a feature on the vehicle and the lane boundary.

6. The method of claim 1, wherein the overlayed distance includes a dimension line extending from the vehicle to the lane boundary.

7. The method of claim 6, wherein the dimension line is labeled with a numerical value of the distance.

8. The method of claim 7, wherein the distance is a lateral distance between a feature on the vehicle and the lane boundary.

9. The method of claim 1, comprising:
f) detecting one or more of a vehicle maneuver, condition, parameter, or location; and
g) selecting a reference point on the vehicle for determining the distance based on the detection in step (f).

10. The method of claim 9, wherein step (g) includes selecting one or more of a tractor tire or a trailer tire as the reference point.

11. A camera monitor system (CMS) for a vehicle, comprising:
a camera configured to provide a captured image of a field of view;
a display in communication with the camera and configured to depict a displayed image comprising at least a portion of the captured image; and
a controller that includes processing circuitry configured to:
detect a lane boundary for the vehicle;
determine a distance between the vehicle and the lane boundary; and
overlay the distance onto the displayed image.

12. The CMS of claim 11, wherein the camera is a rear facing camera mounted to a tractor, and the field of view captures at least a portion of a trailer.

13. The CMS of claim 11, wherein the distance is a lateral distance between a feature on the vehicle and the lane boundary.

14. The CMS of claim 11, wherein the overlayed distance includes a dimension line extending from the vehicle to the lane boundary.

15. The CMS of claim 14, wherein the dimension line is labeled with a numerical value of the distance.

16. The CMS of claim 15, wherein the distance is a lateral distance between a feature on the vehicle and the lane boundary.

17. The CMS of claim 16, wherein the feature is a tire.

18. The CMS of claim 11, wherein the processing circuitry configured to perform the overlay if the distance is less than a predetermined threshold value.

19. The CMS of claim 11, wherein the processing circuitry is configured to:
detect one or more of a vehicle maneuver, condition, parameter, or location; and
select a reference point on the vehicle for determining the distance based on the detection of the one or more of the vehicle maneuver, condition, parameter, or location.

20. The CMS of clam 19, wherein the reference point is a tire.
